(19) United States
(12) Patent Application Publication
(10) Pub. No.: US 2026/0034961 A1
(43) Pub. Date: Feb. 5, 2026

(54) VEHICLE THEFT PREVENTION DEVICE

(71) Applicant: John Paul Detlor, Bowmanville (CA)

(72) Inventor: John Paul Detlor, Bowmanville (CA)

(21) Appl. No.: 19/280,978

(22) Filed: Jul. 25, 2025

Related U.S. Application Data
(60) Provisional application No. 63/677,667, filed on Jul. 31, 2024.

(51) Int. Cl. B60R 25/09

(52) U.S. Cl. CPC B60R 25/09

(57) ABSTRACT

A vehicle theft prevention device that is configured to be operably coupled to a vehicle tire wherein the present invention is opposedly mounted to the vehicle tire so as to inhibit movement of the vehicle. The device includes a first block member and a second block member that are identically constructed. The first and second block member include a first segment and second segment operably coupled with pin members and adjustably movable with respect to each other. The first segment and second segment of the first block member and second block member each have an upper portion and a lower portion contiguously formed. A first swing arm member and a second swing arm member are movably coupled to the first block member and second block member respectively. The first swing arm member and second swing arm member have second ends that are configured to operably couple to a locking member.

### PRIORITY UNDER 35 U.S.C Section 119(e) & 37 C.F.R. Section 1.78

This nonprovisional application claims priority based upon the following prior United States Provisional Patent Application entitled: Vehicle Theft Prevention Device, Application No.: 63/677,667 filed Jul. 31, 2024, in the name of John Paul Detlor, which is hereby incorporated by reference for all purposes.

### FIELD OF INVENTION

The present invention relates generally to vehicle theft protection, more specifically but not by way of limitation, an anti-theft device for a vehicle that is configured to operably couple to a vehicle wheel wherein the present invention mechanically fastens thereto and inhibit the rotation of the wheel.

BACKGROUND

According to research groups and law enforcement data, vehicle thefts in Canada soared in 2022, with both Quebec and Ontario seeing spikes of around fifty percent, while Atlantic Canada saw an increase of more than thirty-four percent. Last June, data stated that Toronto recorded a three hundred percent increase in vehicle thefts from 2015 to 2022, with the amount of car thefts growing progressively worse each year. In 2022, more than 9,600 vehicles were stolen in Toronto alone. Reports have noted an increased demand for vehicles and auto parts that has intensified due to supply chain disruptions affecting the automotive industry, while advancements in car technology, like keyless entry systems, have made it easier for tech-savvy thieves to nab vehicles.

The involvement of organized crime has also led to the establishment of large-scale, well-resourced vehicle theft operations with the proceeds funding domestic drug trafficking, international terrorism and other efforts. Another cause for the increase in vehicle thefts is lack of enforcement, particularly in reduced prosecution for the crimes. In Toronto, Canada a vehicle is stolen every six minutes and the amount of theft is having devastating impact on Canadians. The auto theft crisis has led to over a billion dollars a year in losses and is being orchestrated by organized criminal organizations that are using the revenue to fund other criminal activities, such as the trafficking of guns and drugs. Several news sources have reported that international crime rings are targeting Canada due to the ease of getting away with crime in the country.

It is intended within the scope of the present invention to provide a theft prevention device for a vehicle that can be efficiently attached to a wheel of a car wherein the present invention inhibits removal of the wheel and further facilitates operational movement thereof.

### SUMMARY OF THE INVENTION

It is the object of the present invention to provide a vehicle theft prevention device operable to inhibit operation of the vehicle wherein the present invention includes a body having a first block member and a second block member manufactured from metal releasably securable to a vehicle wheel.

Another object of the present invention is to provide an anti-theft apparatus for a vehicle wherein the first block member and second block member include a first portion and second portion positioned on opposing sides of the vehicle wheel.

A further object of the present invention is to provide a vehicle theft prevention device operable to inhibit operation of the vehicle wherein the first portion of first block member and second block member include a first segment and a second segment.

An additional object of the present invention is to provide a vehicle theft prevention device operable to inhibit operation of the vehicle wherein the first portion of the first block member and second block member of the body include a guide arm members.

Yet a further object of the present invention is to provide an anti-theft apparatus for a vehicle wherein the first portion of the first block member includes a swing arm member having a first end and a second end with the first end being hingedly secured to the first portion.

Another object of the present invention is to provide a vehicle theft prevention device operable to inhibit operation of the vehicle wherein the first portion of the second block member includes a swing arm member having a first end and a second end with the first end being hingedly secured to the first portion.

An alternate object of the present invention is to provide an anti-theft apparatus for a vehicle wherein the second end of the swing arm member operably coupled to the first portion of the body is configured to be releasably secured to the second end of the swing arm member operably coupled to the second portion of the body proximate the midpoint of the vehicle wheel.

Still a further object of the present invention is to provide a vehicle theft prevention device operable to inhibit operation of the vehicle wherein the present invention further includes a torque bar member.

An additional object of the present invention is to provide an anti-theft apparatus for a vehicle wherein the first portion of the body and second portion of the body include pin members configured to movably couple the swing arm members thereto.

Yet another object of the present invention is to provide a vehicle theft prevention device operable to inhibit operation of the vehicle wherein the present invention includes a locking key member.

Still a further object of the present invention is to provide an anti-theft apparatus for a vehicle wherein the body of the present invention has a width that is adjustable.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of an embodiment of the present invention; and

FIG. 2 is a top view of the first segment of the first block member of the present invention; and

FIG. 3 is a top view of the second segment of the second block member of the present invention; and

FIG. 4 is a perspective end view of the first block member of the present invention; and

FIG. 5 is a front view of an embodiment of the present invention.

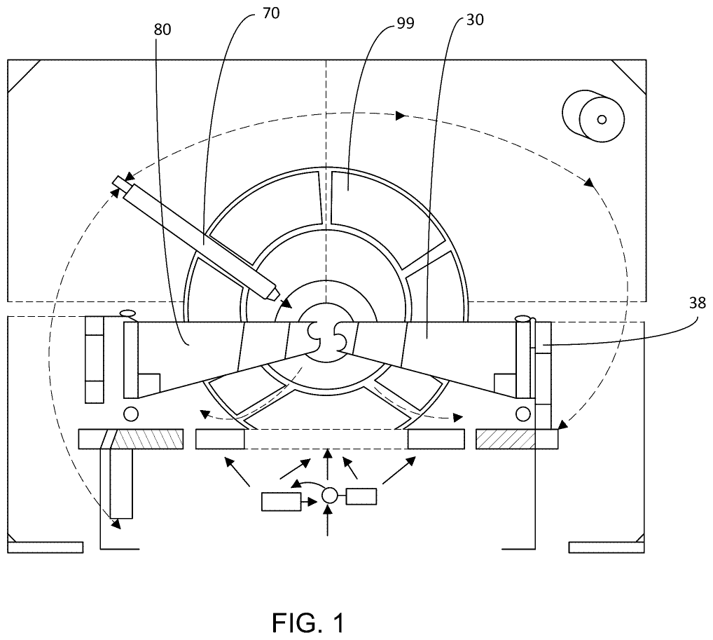

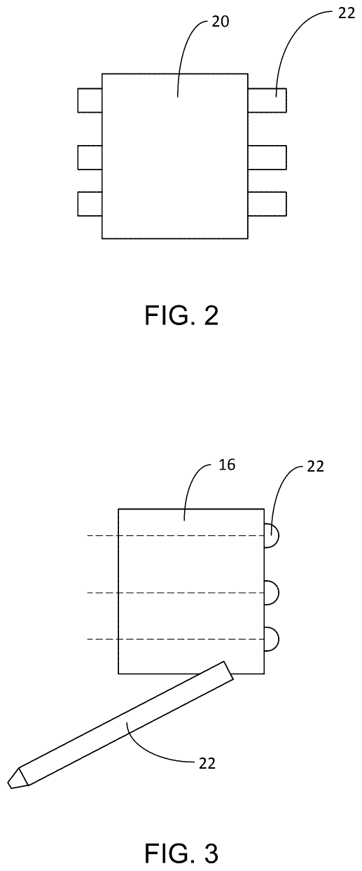

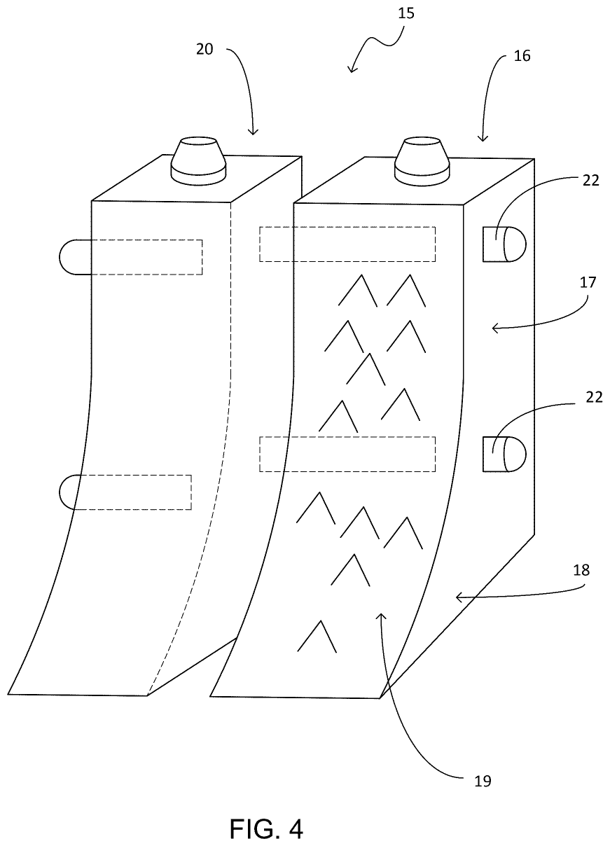

### DETAILED DESCRIPTION

Referring now to the drawings submitted herewith, wherein various elements depicted therein are not necessarily drawn to scale and wherein through the views and figures like elements are referenced with identical reference numerals, there is illustrated a vehicle theft prevention device 100 constructed according to the principles of the present invention

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the vehicle theft prevention device 100 is configured to be operably coupled to a wheel of a vehicle so as to inhibit the movement of the vehicle. While an exemplary embodiment has been illustrated herein, it should be understood within the scope of the present invention that the vehicle theft prevention device 100 could have alternative embodiments that include the elements discussed herein and provide the intended functionality.

The vehicle theft prevention device 100 includes a body 10 having a first block member 15 and a second block member 50 wherein the first block member 15 and second block member 50 are opposedly positioned relative to exemplary tire 99. The first block member 15 and second block member 50 are identically constructed and as such the ensuing discussion on the first block member 15 should be understood to apply to the second block member 50. The first block member 15 is manufactured from a rigid durable material such as but not limited to metal or plastic. The first block member 15 is comprised of a first segment 16 and a second segment 20 wherein the first segment 16 and second segment 20 are identically shaped. The first block member 15 is configured to be placed adjacent one side of tire 99 and the second block member 50 is positioned on the opposing side thereof. The first segment 16 includes upper portion 17 integrally formed with lower portion 18 wherein the first segment 16 includes tire engagement surface 19 that transitions between the upper portion 17 and lower portion 18. The tire engagement surface 19 has a sloped orientation wherein the slope thereof proximate the lower portion 18 has a radius that is generally mateable to the radius of the exemplary tire 99. The first segment 16 and second segment 20 are operably coupled with pin members 22 wherein the pin members 22 are journaled through the first segment 16 and second segment 20 so as to maintain alignment of the first segment 16 and second segment 20. Additionally, the pin members 22 allow for slidable adjustment of the first segment 16 and second segment 22 providing for adjustment of the width therebetween so as to accommodate tires of alternate sizes. It should be understood within the scope of the present invention the vehicle theft prevention device 100 could utilize as few as one pin member 22 or an alternate quantity of pin members 22 to operably coupled the first segment 16 and second segment 20.

The first block member 15 includes swing arm member 30. Swing arm member 30 is hingedly secured to the first segment 16 of the first block member 15 utilizing hinge member 38. The swing arm member 30 is planar in form having a first end 31 and second end 32 wherein the second end 32 is distally located from hinge member 38. The swing arm member 30 is hingedly movable between a first position and a second position. In the second position of the swing arm member 30, the swing arm member 30 is parallel and adjacent tire 99. In the first position, the swing arm member 30 is perpendicular to the tire 99 extending outward away therefrom so as to enable positioning and installation of the first block member 15. The second end 32 of the swing arm member 30 includes slot 37 formed therein wherein the slot 37 includes curved wall member 33. The curved wall member 33 is configured to operably engage locking member 60, specifically the upper hemisphere thereof, wherein rotation of the locking member 60 and the arcuate shape of the curved wall member 33 provides minor movement of the first block member 15 inwards towards the tire 99 creating sufficient bias thereagainst to substantially inhibit removal of the first block member 15 unless the swing arm member 30 is released from the locking member 60. The second end 82 of swing arm member 80 operably coupled to second block member 50 is shaped in an arcuate manner so as to operably couple with the lower hemisphere of the locking member 60. The opposed hemispherical coupling of the swing arm member 30 and swing arm member 80 to the locking member 60 facilitates the inward movement of the first block member 15 and second block member 50 during rotational movement of the locking member 60.

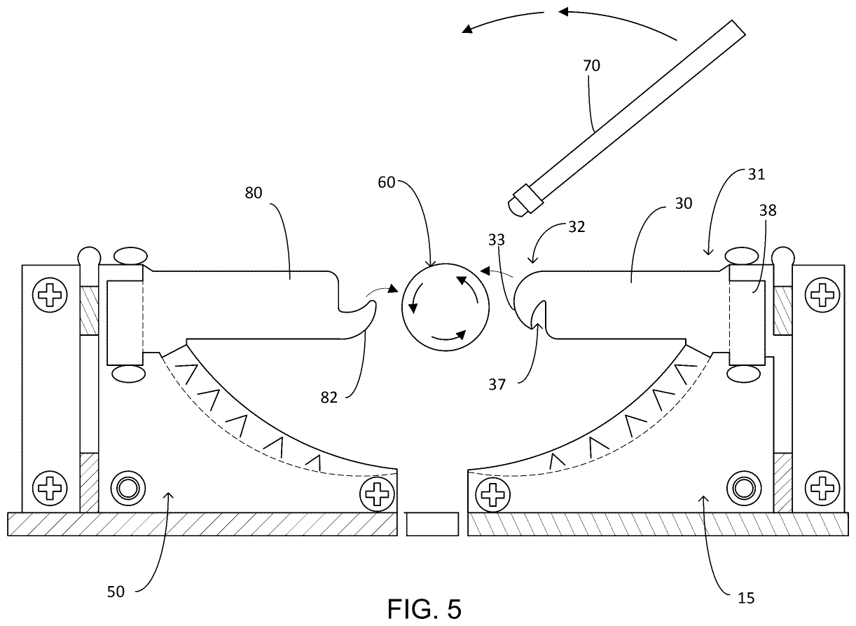

The locking member 60 is rotatably movable and is operated by a wrench member 70 wherein the wrench member 70 is movable in the exemplary direction is indicated herein in FIG. 5. It should be understood within the scope of the present invention that the wrench member 70 could be constructed in numerous alternate manners so as to operably engage with the locking member 60 and provide rotational movement thereof. It is contemplated within the scope of the present invention that the locking member 60 could be constructed in alternate manners and achieve the desired objective discussed herein.

While the first block member 15 and second block member 50 have been illustrated herein in a preferred embodiment, it is contemplated within the scope of the present invention that the first block member 15 and second block member 50 could be constructed in alternate manners and achieve the desired objective discussed herein. Furthermore, as previously discussed herein, the second block member 50 is identically constructed as the first block member 15 having all identical elements thereof.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A vehicle theft prevention device that is configured to be operably coupled with at least one tire on a vehicle wherein the vehicle theft prevention device comprises:
a first block member, said first block member having a first segment and a second segment, said first segment and said second segment being identically formed, said first segment and said second segment being operably coupled with at least one pin member, said first segment and said second segment being movable with respect to each other maintaining alignment with said at least one pin member;
a second block member, said second block member having a first segment and a second segment, said first segment and said second segment of said second block member being identically formed, said first segment and said second segment of said second block member being operably coupled with at least one pin member, said first segment and said second segment of said second block member being movable with respect to each other maintaining alignment with said at least one pin member of said second block member;
a first swing arm member, said first swing arm member being hingedly coupled to said first block member with a hinge member, said first swing arm member having a first end and a second end, said second end of said first swing arm member being distally located to said hinge member, said first swing arm member having a first position and a second position;
a second swing arm member, said second swing arm member being hingedly coupled to said first block member of said second block member with a hinge member, said second swing arm member having a first end and a second end, said second end of said second swing arm member being distally located to said hinge member operably coupled to said second swing arm member, said second swing arm member having a first position and a second position; and
a locking member, said locking member being intermediate said first swing arm member and said second swing arm member in said first positions thereof, said locking member configured to operably couple with said second end of said first swing arm member and said second end of said second swing arm member.

2. The vehicle theft prevention device that is configured to be operably coupled with at least one tire on a vehicle as recited in claim 1, wherein said first segment of said first block member includes an upper portion and a lower portion being contiguously formed, said first segment further having a tire engagement surface extending across said upper portion and said lower portion that is arcuate in form proximate said lower portion.

3. The vehicle theft prevention device that is configured to be operably coupled with at least one tire on a vehicle as recited in claim 2, wherein said second segment of said first block member includes an upper portion and a lower portion being contiguously formed, said second segment further having a tire engagement surface extending across said upper portion and said lower portion of said second segment of said first block member that is arcuate in form proximate said lower portion of said second segment of said first block member.

4. The vehicle theft prevention device that is configured to be operably coupled with at least one tire on a vehicle as recited in claim 3, wherein said first segment of said second block member includes an upper portion and a lower portion being contiguously formed, said first segment of said second block member further having a tire engagement surface extending across said upper portion and said lower portion of said first segment of said second block member that is arcuate in form proximate said lower portion of said first segment of said second block member.

5. The vehicle theft prevention device that is configured to be operably coupled with at least one tire on a vehicle as recited in claim 4, wherein said second segment of said second block member includes an upper portion and a lower portion being contiguously formed, said second segment of said second block member further having a tire engagement surface extending across said upper portion and said lower portion of said second segment of said second block member that is arcuate in form proximate said lower portion of said second segment of said second block member.

6. The vehicle theft prevention device that is configured to be operably coupled with at least one tire on a vehicle as recited in claim 5, wherein said second end of said first swing arm includes a slot, said slot of said second end of said first swing arm configured to operably couple with an upper hemisphere of said locking member.

7. The vehicle theft prevention device that is configured to be operably coupled with at least one tire on a vehicle as recited in claim 6, wherein said second end of said second swing arm includes a slot, said slot of said second end of said second swing arm configured to operably couple with a lower hemisphere of said locking member.

8. The vehicle theft prevention device that is configured to be operably coupled with at least one tire on a vehicle as recited in claim 7, and further including a wrench member, said wrench member configured to be operably coupled with said locking member and provide rotational movement thereof.

9. The vehicle theft prevention device that is configured to be operably coupled with at least one tire on a vehicle as recited in claim 8, wherein in said first position said first swing arm member is adjacent to and parallel with the at least one tire.

10. The vehicle theft prevention device that is configured to be operably coupled with at least one tire on a vehicle as recited in claim 9, wherein in said first position said second swing arm member is adjacent to and parallel with the at least one tire.
